(19) United States
(12) Patent Application Publication
(10) Pub. No.: US 2005/0112424 A1
(43) Pub. Date: May 26, 2005

(54) Fuel cell system

(76) Inventors: Takayuki Hirano, Kariya-shi (JP); Kazuho Yamada, Kariya-shi (JP); Masanao Kagami, Kariya-shi (JP); Toshiro Fujii, Kariya-shi (JP); Tatsuyuki Hoshino, Kariya-shi (JP); Katsutoshi Shiromaru, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/993,975

(22) Filed: Nov. 19, 2004

(30) Foreign Application Priority Data
Nov. 25, 2003 (JP) 2003-394103
Nov. 20, 2003 (JP) 2003-390790

(51) Int. Cl. H01M 8/18

(52) U.S. Cl. 429/20

(57) ABSTRACT

A fuel cell system includes a fuel cell stack, a hydrogen flowing passage, an air flowing passage and a control valve. At least one of the gas flowing passages includes a bypass, a selecting means, a gas flowing means and a control unit. The bypass allows a gas to flow therethrough so as to detour the fuel cell stack and the control valve. The selecting means selects one of a passage which passes through the fuel cell stack and the bypass. The gas flowing means flows the gas to the bypass. In the control unit, the through passage is selected by the selecting means when the system is operated, The bypass is selected by the selecting means when the operation of the system is stopped. The gas is flowed to the bypass by operating the gas flowing means when the control valve is frozen thereby heating the control valve.

### BACKGROUND OF THE INVENTION

The present invention relates to a fuel cell system and, in particular, to a fuel cell system which generates electricity by supplying hydrogen and air to a fuel cell stack respectively through a hydrogen flowing passage and an air flowing passage.

In recent years, a fuel cell system, which generates electricity through electrochemical reaction of hydrogen and oxygen, has been attracted as an energy source. If an outdoor air temperature drops to below zero in such a fuel cell system, moisture in a gas exhausted from a stack of a fuel cell condenses and freezes on a control valve such as an exhaust valve or a check valve which is located on the gas flowing passage, or a moisture remaining in the gas flowing passage freezes on the control valve, thereby preventing the control valve from openirig and closing. In this case, the system is not started until a freeze of the control valve is dissolved, and a relatively long time is needed until the system is started.

On the other hand, a fuel cell system disclosed in Japanese Unexamined Patent Publication 2002-313389 has the following features. This prior art fuel cell system has arranged a control valve such as an exhaust valve or a check valve in a warm-up box, a flow dividing passage which interconnects the downstream of an air compressor and the warm-up box, and a flow dividing valve which allows the flow dividing passage to be circulated or to be cut off. When the control valve is frozen, the flow dividing passage is opened between the downstream of an air compressor and the warm-up box by opening the flow dividing valve, thereby supplying the high-temperature air which is obtained by adiabatic compression in the air compressor into the warm-up box. Thus, the control valve is heated and thawed.

The prior art fuel cell system, however, needs to arrange therein not only the warm-up box, which accommodates the control valve, but also both of the flow dividing passage, which interconnects the downstream of an air compressor and the warm-up box, and the flow dividing valve, which allows the flow dividing passage to be circulated or to be cut off, need to be arranged. Therefore, the prior art fuel cell system has a complicated structure as a whole.

Although each control valve may be heated by installing thereon a heating unit such as a heater, each control valve needs to install thereon an exclusive heating unit. Therefore, even in this case, the fuel cell system has a complicated structure as a whole.

On the other hand, if the outdoor air temperature drops to below zero, moisture in a gas existing inside a hydrogen pump is also frozen in the hydrogen pump. Even if the operation of the pump is started in a state where the control valve is frozen, the pump is of being driven by ice frozen in the pump. In a case where the pump is thus incapable of being driven, the control valve is not heated even if the warm-up box described in the prior art fuel cell system is used, and a relatively long time is needed until the system is started.

### SUMMARY OF THE INVENTION

The present invention is directed to a simply structured fuel cell system whose operation is started at an early stage by efficiently heating a control valve.

The present invention provides the following feature. A fuel cell system includes a fuel cell stack, a hydrogen flowing passage, an air flowing passage and a control valve. In the fuel cell stack, electricity is generated through reaction of hydrogen and air. The hydrogen flowing passage is connected to the fuel cell stack for allowing the hydrogen to be supplied to the fuel cell stack. The air flowing passage is connected to the fuel cell stack for allowing the air to be supplied to the fuel cell stack. The control valve is located on the hydrogen flowing passage and the air flowing passage. At least one gas flowing passage of the hydrogen flowing passage and the air flowing passage includes a bypass, a selecting means, a gas flowing means and a control unit. The bypass allows a gas to flow therethrough so as to detour the fuel cell stack and the control valve. The selecting means selects one of a passage which passes through the fuel cell stack and the bypass. The gas flowing means flows the gas to the bypass. The control unit is connected to the control valve, the selecting means and the gas flowing means such that the through passage is selected by the selecting means when the system is operated, that the bypass is selected by the selecting means when the operation of the system is stopped, and that the gas is flowed to the bypass by operating the gas flowing means in a case where the control valve is frozen thereby heating the control valve.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments, together with the accompanying drawings, in which:

FIG. 1 is a schematic view showing a fuel cell system according to a first preferred embodiment of the present invention;

FIG. 2 is a schematic view showing a fuel cell system according to a second preferred embodiment of the present invention;

FIG. 3 is a schematic view showing a fuel cell system provided with an anti-icing system according to a third preferred embodiment of the present invention; and

FIG. 4 is a schematic view showing another fuel cell system provided with the anti-icing system according to the third preferred embodiment of the present invention.

### DETAILED DESCRIPTION OF THE PREFERRED EMBODIMENTS

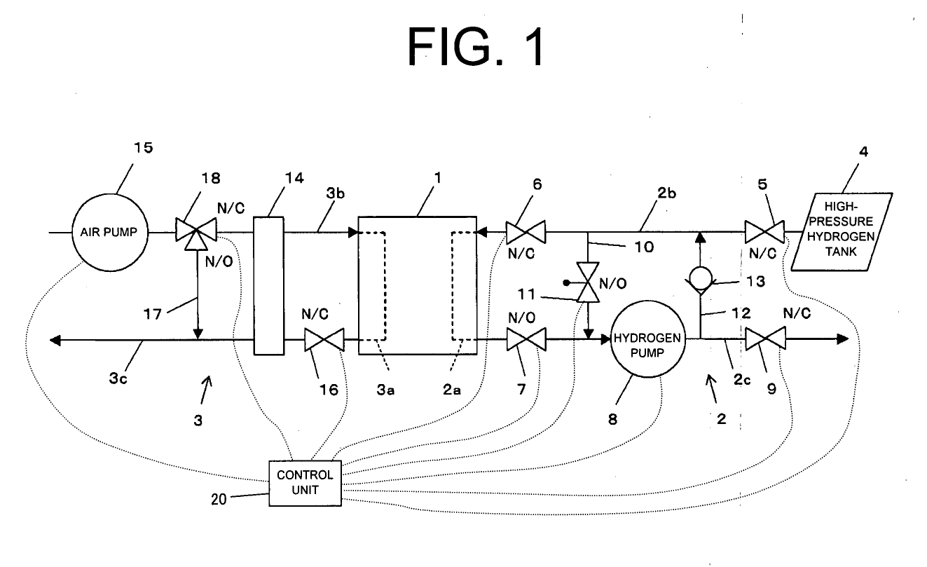

A fuel cell system according to a first preferred embodiment of the present invention will now be described with reference to FIG. 1.

FIG. 1 shows a schematic view of the fuel cell system according to the first preferred embodiment of the present invention. It is noted that the reference marks “N/O”, “N/C” respectively denote “normal open” and “normal close”. The fuel cell system includes a stack 1 of a fuel cell (hereinafter referred to a FC stack 1) in which electricity is generated through electrochemical reaction of hydrogen and atmospheric oxygen, and is capable of using electric power which is generated by the FC stack 1 as a drive source of a vehicle. Also, the fuel cell system includes a hydrogen flowing passage 2 for allowing hydrogen to be supplied to a hydrogen electrode of the FC stack 1 and an air flowing passage 3 for allowing air (or oxygen) to be supplied to an oxygen electrode of the FC stack 1.

The hydrogen flowing passage 2 includes a passage 2a which passes through the FC stack 1 for allowing hydrogen to be supplied to the hydrogen electrode (hereinafter referred to a first through passage 2a), a first supplying passage 2b which is connected to a supplying side of the first through passage 2a, and a first exhaust passage 2c which is connected to an exhausting side of the first through passage 2a. To the first supplying passage 2b is connected a high-pressure hydrogen tank 4, and first and second pressure regulating valves 5, 6 are located down the hydrogen tank 4. On the other hand, on the first exhaust passage 2c is located a first back pressure regulating valve 7 for regulating the pressure in the FC stack 1, and down the first back pressure regulating valve 7 is located a hydrogen pump 8 such as provided by a Roots compressor. Further, down the hydrogen pump 8 is located a first shut-off valve 9. The downstream of the first shut-off valve 9 is opened to the atmosphere. It is noted that the first and second pressure regulating valves 5, 6, the first back pressure regulating valve 7 and the first shut-off valve 9 each serve as a control valve.

Between the first supplying passage 2b and the first exhaust passage 2c is formed a first bypass 10 which detours the FC stack 1, the second pressure regulating valve 6 and the first back pressure regulating valve 7, and on the first bypass 10 is located a second shut-off valve 11 that serves as a selecting means. Down the hydrogen pump 8 is formed a first gas circulating passage 12 for allowing hydrogen off-gas, which is exhausted from the first through passage 2a of the FC stack 1 to the first exhaust passage 2c, to be circulated toward the first supplying passage 2b by the hydrogen pump 8. On the first gas circulating passage 12 is located a check valve 13 for preventing a gas from flowing backward from the first supplying passage 2b to the first exhaust passage 2c. The check valve 13 serves as a control valve.

In a similar manner to the hydrogen flowing passage 2, the air flowing passage 3 also includes a passage 3a which passes through the FC stack 1 for allowing air (or oxygen) to be supplied to the oxygen electrode (hereinafter referred to a second through passage 3a), a second supplying passage 3b which is connected to a supplying side of the second through passage 3a, and a second exhaust passage 3c which is connected to an exhausting side of the second through passage 3a. The upstream of the second supplying passage 3b and the downstream of the second exhaust passage 3c are opened to the atmosphere. On the second supplying passage 3b and the second exhaust passage 3c is located a humidification module 14. In the upstream of the humidification module 14 of the second supplying passage 3b is located the air pump 15 such as provided by a Roots compressor. On the other hand, in the upstream of the humidification module 14 of the second exhaust passage 3c is located a second back pressure regulating valve 16 for regulating the pressure in the FC stack 1. The second back pressure regulating valve 16 serves as a control valve.

Between the second supplying passage 3b and the second exhaust passage 3c is formed a second bypass 17 for detouring the FC stack 1, the second back pressure regulating valve 16 and the humidification module 14. At a point at which the second bypass 17 branches off from the second supplying passage 3b is located a three-way valve 18.

The fuel cell system according to the present embodiment of the present invention includes a control unit 20, to which the hydrogen pump 8, the first pressure regulating valve 5, the second pressure regulating valve 6, the first back pressure regulating valve 7, the first shut-off valve 9, the second shut-off valve 11 in the first bypass 10, the air pump 15, the second back pressure regulating valve 16 and the three-way valve 18 are each electrically connected.

In a normal operation of the fuel cell system, the control unit 20 opens the first and second pressure regulating valves 5,6, and regulates an opening of the first back pressure regulating valve 7, and closes the first shut-off valve 9 and the second shut-off valve 11 in the first bypass 10. In addition, the control unit 20 regulates an opening of the second back pressure regulating valve 16, and selects the second through passage 3a by adjusting the three-way valve 18 such that the second bypass 17 is cut off.

In the normal operation of the fuel cell system, while hydrogen which has been supplied from the hydrogen tank 4 to the first supplying passage 2b of the hydrogen flowing passage 2 is supplied to the first through passage 2a at a predetermined pressure through the first and second pressure regulating valves 5, 6, air is supplied from the air pump 15 of the air flowing passage 3 to the second through passage 3a through the second supplying passage 3b. Such hydrogen and atmospheric oxygen thus supplied into the FC stack 1 electrochemically reacts with each other thereby generating electricity. At this time, a part of hydrogen off-gas which has been exhausted from the FC stack 1 to the first exhaust passage 2c of the hydrogen flowing passage 2 is circulated to the first supplying passage 2b through the first gas circulating passage 12 by the hydrogen pump 8. Thus, unused hydrogen in hydrogen off-gas is circulated to the first supplying passage 2b through the first gas circulating passage 12 and is reused in the FC stack 1.

When the operation of the fuel cell system is stopped, the control unit 20 closes the first and second pressure regulating valves 5,6, and opens the first back pressure regulating valve 7 and the first shut-off valve 9 such that the internal space of the FC stack 1 is opened to atmosphere. In addition, the control unit 20 closes the second back pressure regulating valve 16.

Further, while the control unit 20 opens the second shut-off valve 11 in the first bypass 10 and circulates the first bypass 10, the control unit 20 selects the second bypass 17 by adjusting the three-way valve 18 such that the air flow toward the second through passage 3a is cut off. Thereafter, the control unit 20 closes the first shut-off valve 9 in the hydrogen flowing passage 2.

If an outdoor air temperature drops to below zero, and moisture in hydrogen-off gas and air in a state where the operation of the fuel cell system is stopped condenses and freezes accordingly, or if moisture remaining in the hydrogen flowing passage 2 and the air flowing passage 3 condenses, the control valve such as the first back pressure regulating valve 7 in the hydrogen flowing passage 2 or the second back pressure regulating valve 16 in the air flowing passage 3 may fail to operate due to its freezing when the operation of the fuel cell system is started. When the control unit 20 detects the freeze of the control valve, the control unit 20 operates the hydrogen pump 8 and the air pump 15 prior to starting the fuel cell system. The hydrogen pump 8 and the air pump 15 each serve as a means for flowing a gas.

At this time, since the second shut-off valve 11 in the first bypass 10 is opened and the first shut-off valve 9 is closed, air is flowed into the first bypass 10 by the hydrogen pump 8 and the second pressure regulating valve 6 and the first back pressure regulating valve 7 which are located near the first bypass 10 are heated, accordingly. In addition, the second shut-off valve 11 in the first bypass 10 also serves as a back pressure regulating valve for regulating the back pressure in the hydrogen pump 8, and adiabatic compression of air is achieved in the upstream side of the second shut-off valve 11 thereby producing a high-pressure heating gas.

Since the three-way valve 18 selects the second bypass 17, air is flowed into the second bypass 17 by the air pump 15 and the humidification module 14 and the second back pressure regulating valve 16 which are located near the second bypass 17 are heated, accordingly. In addition, the three-way valve 18 also serves as a back pressure regulating valve for regulating the back pressure in the air pump 15, and adiabatic compression of air is achieved in the upstream side of the three-way valve 18 thereby producing a high-pressure heating gas.

Thus, air is flowed into the first bypasses 10 in the hydrogen flowing passage 2 and the second bypass 17 in the air flowing passage 3, and the frozen control valve is efficiently heated and thawed, accordingly. Therefore, each control valve does not need an exclusive heating unit such as a heater to be installed, and the control valve is efficiently heated by a simple system configuration. Consequently, the whole system is efficiently warmed up, thereby starting the system at an early stage.

Since, in a state where the control valve is heated the second pressure regulating valve 6 in the hydrogen flowing passage 2 is closed thereby cutting off the upstream side of the second shut-off valve 11 in the first bypass 10 and the first through passage 2a, the high-pressure air compressed by the hydrogen pump 8 does not be applied to the first through passage 2a. That is, there is no fear that the internal portion of the FC stack 1 is damaged. In addition, since the first through passage 2a is in communication with the downstream side of the second shut-off valve 11 in the first bypass 10, it is possible that the decompressed heating air reaches the first through passage 2a. Therefore, it is possible that the internal portion of the FC stack 1 is warmed up.

In a similar manner to the hydrogen flowing passage 2, since the three-way valve 18 in the air flowing passage 3 selects the second bypass 17 thereby cutting off the upstream side of the three-way valve 18 in the second supplying passage 3b and the second through passage 3a, the high-pressure air compressed by the air pump 15 does not be applied to the second through passage 3a. That is, there is no fear that the internal portion of the FC stack 1 is damaged.

When the hydrogen pump 8 in the hydrogen flowing passage 2 flows air into the first bypass 10, the first bypass 10, the hydrogen pump 8 and the first gas circulating passage 12 forms a closed circuit, in which air is circulated and adiabatic compression thereof is achieved by the hydrogen pump 8 such that the compressed air reaches a predetermined temperature. Therefore, even if the first pressure regulating valve 5, the check valve 13 and the first shut-off valve 9 freeze, they are heated and thawed by the circulated air. Thus, the whole system including the control valve is efficiently warmed up.

By previously opening the second shut-off valve 11 in the first bypass 10 and selecting the second bypass 17 by the three-way valve 18 when the operation of the fuel cell system is stopped, even if the second shut-off valve 11 in the hydrogen flowing passage 2 and the three-way valve 18 in the air flowing passage 3 are frozen when the operation of the fuel cell system is started, air is flowed into the first bypass 10 in the hydrogen flowing passage 2 and the second bypass 17 in the air flowing passage 3 by driving the hydrogen pump 8 and the air pump 15, thereby heating the control valve.

In an alternative embodiment to the above-described first preferred embodiment, in place of opening the FC stack 1 to the atmosphere by opening the first back pressure regulating valve 7 and the first shut-off valve 9 in a state where the operation of the fuel cell system is stopped, the control unit 20 closes the second pressure regulating valve 6 and the first back pressure regulating valve 7 and opens the first pressure regulating valve 5, the first shut-off valve 9 and the second shut-off valve 11 in the first bypass 10 before the operation of the fuel cell system is stopped, thereby flowing the dry hydrogen which has not passed through the FC stack 1 from the hydrogen tank 4 to the hydrogen pump 8 through the first pressure regulating valve 5 and the second shut-off valve 11 in the first bypass 10 such that the hydrogen flowing passage 2 is scavenged. Thereafter, the first pressure regulating valve 5 and the first shut-off valve 9 are closed and the operation of the fuel cell system is stopped. In this case, since the first pressure regulating valve 5, the second pressure regulating valve 6, the first back pressure regulating valve 7 and the first shut-off valve 9 are closed and the second shut-off valve 11 in the first bypass 10 is opened in a state where the operation of the fuel cell system is stopped, the dry hydrogen remains in the closed circuit, which is formed by the first bypass 10, the hydrogen pump 8 and the first gas circulating passage 12. Therefore, if the hydrogen pump 8 is operated in a state where the control valve is frozen, the dry hydrogen is circulated in the closed circuit. Thus, since hydrogen is flowed into the first bypass 10 thereby heating the control valve, the similar effects to those of the first preferred embodiment are obtained.

In an alternative embodiment to the above-described alternative embodiment, in a case where the dry hydrogen is flowed from the hydrogen tank 4 to the hydrogen pump 8 through the first pressure regulating valve 5 and the second shut-off valve 11 in the first bypass 10 such that the hydrogen flowing passage 2 is scavenged before the operation of the fuel cell system is stopped and thereafter the operation of the fuel cell system is stopped in a state where the second shut-off valve 11 in the first bypass 10 is opened, the control unit 20 opens the first pressure regulating valve 5 and operates the hydrogen pump 8 in a state where the control valve is frozen such that hydrogen is flowed from the hydrogen tank 4 to the first bypass 10 thereby heating the control valve. Thus, the similar effects to those of the first preferred embodiment are obtained.

In the above-described first preferred embodiment, if the first bypass 10 in the hydrogen flowing passage 2 provides a throttle thereon, or if the diameter of the piping of the first bypass 10 is formed so as to be smaller than that of the hydrogen flowing passage 2, or if both of the above structures in the first bypass 10 are practiced, to the hydrogen pump 8 is further applied load thereby flowing relatively high-temperature gas into the first bypass 10. Consequently, efficiency for warming up the fuel cell system is improved. In a similar manner to the hydrogen flowing passage 2, if the second bypass 17 in the air flowing passage 3 provides a throttle thereon, or if the diameter of the piping of the second bypass 17 is formed so as to be smaller than that of the air flowing passage 3, or if both of the above structures in the second bypass 17 are practiced, to the air pump 15 is further applied load thereby flowing relatively high-temperature gas into the second bypass 17. Consequently, the efficiency for warming up the fuel cell system is improved.

In place of providing the second shut-off valve 11 in the first bypass 10, a three-way valve similar to the three-way valve in the air flowing passage 3 may be arranged at a point at which the first bypass 10 branches off from the first supplying passage 2b. At this time, if an opening of the three-way valve in a case where the three-way valve selects the first through passage 2a is adjusted so as to have the same opening as that of the second pressure regulating valve 6, the second pressure regulating valve 6 is not needed.

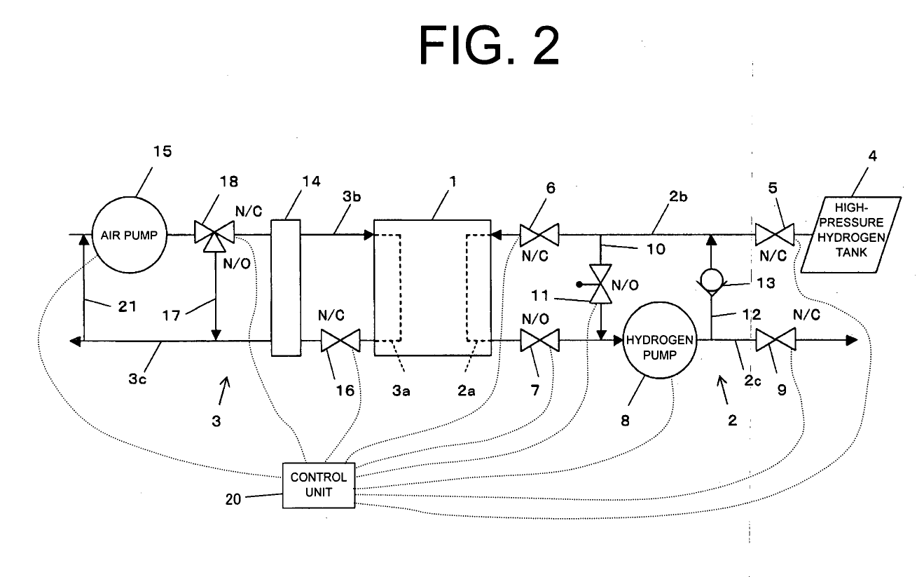

A fuel cell system according to a second preferred embodiment of the present invention will now be described with reference to FIG. 2. The fuel cell system according to the second preferred embodiment of the present invention provides a gas second circulating passage 21 in the air flowing passage 3 in the fuel cell system according to the first preferred embodiment of the present invention, which is shown in FIG. 1. Specifically, the second gas circulating passage 21 is arranged in the air flowing passage 3 such that one end thereof is connected to the upstream side of the air pump 15 and the other end thereof is connected to the downstream side of the point at which the second bypass 17 branches off from the second exhaust passage 3c. Since the structure and operation of the hydrogen flowing passage 2 of the second preferred embodiment are substantially the same as those of the first preferred embodiment, explanation thereof is omitted.

Even in a case where the second gas circulating passage 21 is thus arranged in the air flowing passage 3, if the control unit 20 operates the air pump 15 in a state where the control valve is frozen, air is flowed into the second bypass 17 so as to detour the FC stack 1, the second back pressure regulating valve 16 and the humidification module 14 thereby heating the control valve. Thus, the similar effects to those of the first preferred embodiment are obtained.

In addition, since the fuel cell system according to the second preferred embodiment of the present invention has the second gas circulating passage 21, the second bypass 17, the air pump 15 and the second gas circulating passage 21 form a closed circuit, in which air is circulated and adiabatic compression thereof is achieved by the air pump 15 such that the compressed air reaches a predetermined temperature. Thus, the whole system including the control valve is efficiently warmed up.

In the above-described second preferred embodiment, if the second gas circulating passage 21 in the air flowing passage 3 provides a throttle thereon, or if the diameter of the piping of the second gas circulating passage 21 is formed so as to be smaller than that of the air flowing passage 3, or if both of the above structures in the second gas circulating passage 21 are practiced, to the air pump 15 is further applied load. Therefore, relatively high-temperature gas is flowed. Consequently, efficiency of warming up the fuel cell system is improved. In a case where load is thus applied to the air pump 15, in the downstream side of the point at which the second gas circulating passage 21 branches off from the second exhaust passage 3c, a shut-off valve which is closed during warming up the fuel cell system or during heating the control valve needs to be arranged.

In the above-described first and second preferred embodiments, the control unit 20 is provided with an outdoor air temperature sensor for detecting outdoor air temperature, thereby detecting freezing of the control valve when outdoor air temperature measured by the outdoor air temperature sensor becomes equal to or lower than a predetermined temperature. The control unit 20 is also provided with a state sensor for detecting an opening state of the control valve, and may judge that the control valve is frozen when the opening state of the control valve detected by the state sensor becomes an unexpected state in controlling the opening state of the control valve. In this case, whether the control valve is frozen or not is detected every control valve. Although, in the above-described first and second preferred embodiments the control unit 20 operates both of the hydrogen pump 8 and the air pump 15 in a state where the control valve is frozen, in a case where a freezing state is thus detected every control valve, only one pump in a gas flowing passage having at least a frozen control valve of the hydrogen flowing passage 2 and the air flowing passage 3 may be operated. In this case, electric power spent on warming-up of the fuel cell system before the operation of the fuel cell system is started is reduced, thereby materializing an energy-saving fuel cell system.

In a case where each fuel cell system according to the above-described first and second preferred embodiments is a battery drive type, the control unit 20 desirably controls operating time of the hydrogen pump 8 and the air pump 15, or thawing time thereof, and flow rate of gas which is circulated by these pumps 8, 11 in accordance with charging capacity of the battery such that the charging capacity needed to operate the fuel cell system after the operation of the fuel cell system is started is ensured.

Also, the thawing time may be previously set in the control unit 20, thereby warming up the fuel cell system for the set time. Also, an outdoor air temperature sensor may be arranged in the fuel cell system thereby varying the thawing time in accordance with the outdoor air temperature which is measured by the outdoor air temperature sensor. Also, as described above, the control unit 20 may be provided with the state sensor for detecting the opening state of the control valve so as to stop warming-up and start the operation of the fuel cell system when the opening state of the control valve detected by the state sensor becomes a desirable opening state.

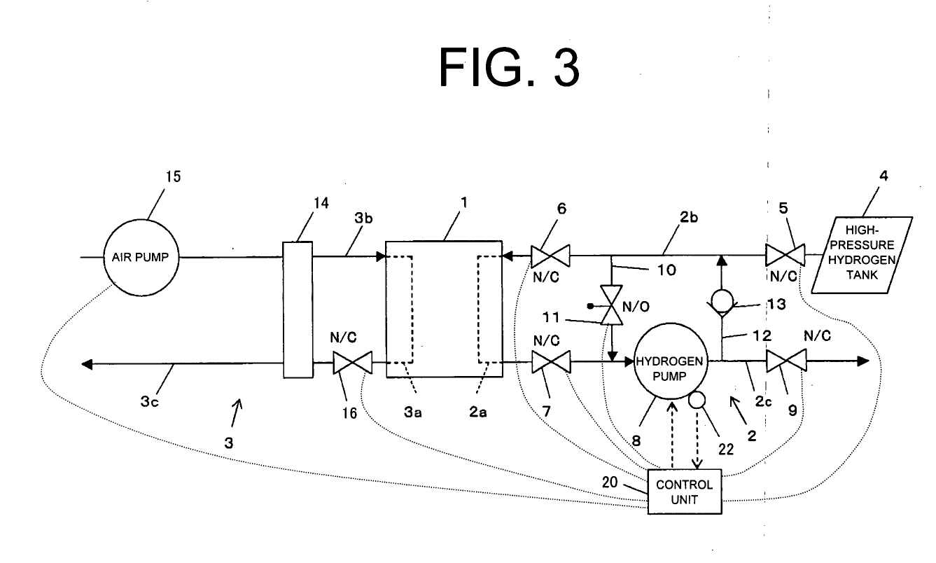

A fuel cell system according to a third preferred embodiment of the present invention will now be described with reference to FIG. 3. The fuel cell system according to the third preferred embodiment of the present invention is lo different from that according to the first preferred embodiment of the present invention in that the second bypass 17, which detours the FC stack 1, the second back pressure regulating valve 16 and the humidification module 14 formed between the second supplying passage 3b and the second exhaust passage 3c, and the three-way valve 18, at a point at which the second bypass 17 branches off from the second supplying passage 3b, are eliminated from the fuel cell system according to the first preferred embodiment of the present invention, which is shown in FIG. 1. The fuel cell system according to the third preferred embodiment of the present invention also prevents the hydrogen pump 8 from freezing. If the hydrogen pump 8 freezes, since not only the hydrogen pump 8 is in capable of being driven but also the control valve is incapable of being heated, the adoption of the present preferred embodiment is effective. Since the structure and operation of the hydrogen flowing passage 2 of the present preferred embodiment are similar to those of the first preferred embodiment or other alternative embodiments to the first preferred embodiment, explanation for the structure and operation is omitted. The relation between the hydrogen pump 8 and a temperature sensor 22, which is relevant to the present preferred embodiment, will be referred to.

In the hydrogen pump 8 is installed the temperature sensor 22 for detecting temperature of the hydrogen pump 8, and each of the hydrogen pump 8 and the temperature sensor 22 is electrically connected to the control unit 20. The control unit 20 has a plurality of reference temperatures “t1” to “tn”, which are different from each other. The relation between “t1” to “tn” is “t1>t2 . . .>tn”. It is noted that the control unit 20 and the temperature sensor 22 form an anti-icing system for the hydrogen pump 8.

When the operation of the fuel cell system is stopped, into the hydrogen pump 8 is flowed the dry hydrogen which has not passed through the FC stack 1 from the high-pressure hydrogen tank 4 though the first bypass 10 before the operation of the fuel cell system is stopped. Even if the operation of the fuel cell system is stopped thus after the hydrogen pump 8 is scavenged, as the temperature in the fuel cell system drops, moisture in the gas in the hydrogen pump 8 of the hydrogen flowing passage 2 condenses and remains in the hydrogen pump 8. If a temperature T of the hydrogen pump 8 detected by the temperature sensor 22 drops, for example, to the reference temperature “t1” in a state where the operation of the fuel cell system is stopped, the hydrogen pump 8 is operated for a predetermined time by the control unit 20 of the anti-icing system, and the moisture remaining in the hydrogen pump 8 and the gas including the moisture are exhausted outside the hydrogen pump 8, accordingly. At this time, the first bypass 10, the hydrogen pump 8 and the first gas circulating passage 12 form a closed circuit, and the gas which is obtained by adiabatic compression in the hydrogen pump 8 circulates in the closed circuit, thereby promoting desiccation in the hydrogen pump 8.

In addition, every time the temperature T of the hydrogen pump 8 drops to reach the reference temperatures “t2” to “tn”, the hydrogen pump 8 is operated for a predetermined time by the control unit 20.

Since the moisture and the gas including.the moisture in which there is fear of freezing in a low-temperature state are thus exhausted outside the hydrogen pump 8 by the anti-icing system, a state incapable of driving the hydrogen pump 8 caused by the freeze of the moisture is avoided even if the outdoor air temperature drops, for example, to below zero. Therefore, the hydrogen pump 8 is easily driven even under a low temperature when the operation of the fuel cell system is started, thereby warming up the fuel cell system such that the fuel cell system is started at an early stage.

Also, the control unit 20 has a plurality of the reference temperatures “t1” to “tn” and, after the temperature T of the hydrogen pump 8 becomes a relatively high-temperature state by operation of the system, the temperature T of the hydrogen pump 8 is gradually lowered by the stop of the system. Every time the temperature T of the hydrogen pump 8 reaches any value of the reference temperatures “t1” to “tn”, the hydrogen pump 8 is operated for a predetermined time by the control unit 20. Therefore, the moisture in the hydrogen pump 8 and the gas including the moisture are efficiently exhausted outside the pump 8.

In the third preferred embodiment, when or after the temperature T of the hydrogen pump 8 detected by the temperature sensor 22 reaches any value of the reference temperatures “t1” to “tn” and the control unit 20 operates the hydrogen pump 8, the control unit 20 opens the first shut-off valve 9 for a predetermined time such that the hydrogen pump 8 is opened to the atmosphere, thereby exhausting a liquefied moisture and the gas including the moisture which are exhausted from the inside of the hydrogen pump 8 to the first exhaust passage 2c outside the fuel cell system. If the moisture and the gas including the moisture in which there is fear of freezing under a low-temperature state are thus exhausted outside the fuel cell system, there is no fear of freezing. Therefore, the fuel cell system is capable of being started further at an early stage.

Also, in a case where the first shut-off valve 9 is opened to the atmosphere when the hydrogen pump 8 is operated, the control unit 20 may further opens the first pressure regulating valve 5 of the fuel cell system such that hydrogen is supplied from the hydrogen tank 4 into the hydrogen pump 8. In this case, hydrogen supplied from the hydrogen tank 4 is flowed into the hydrogen pump 8 through the first bypass 10 thereby further promoting desiccation in the hydrogen pump 8.

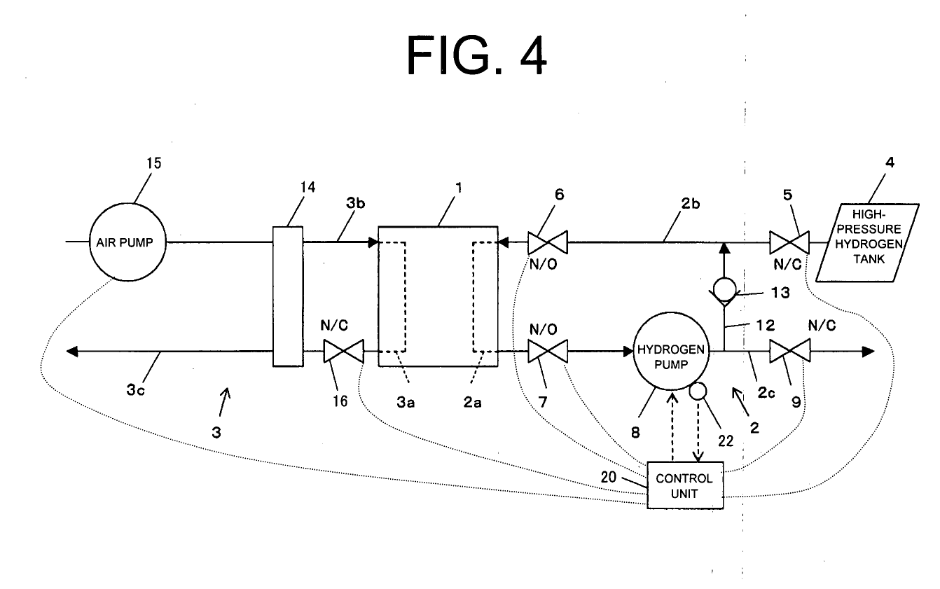

If the first bypass 10 which detours the FC stack 1 of the hydrogen flowing passage 2 of the fuel cell system is eliminated from FIG. 3, as shown in FIG. 4, anti-freeze of the hydrogen pump 8 becomes the first purpose. In this case, after the first pressure regulating valve 5, the second pressure regulating valve 6, the back pressure regulating valve 7 and the first shut-off valve 9 in the hydrogen flowing passage 2 are opened such that the hydrogen flowing passage 2 is scavenged as a whole, even in a case where the first pressure regulating valve 5 and the first shut-off valve 9 are closed and the operation of the system is stopped, and thereafter the control unit 20 operates the hydrogen pump 8 for a predetermined time when the temperature T of the hydrogen pump 8 detected by the temperature sensor 14 reaches any value of the reference temperatures “t1” to “tn”, the moisture and the gas including the moisture are exhausted from the hydrogen pump 8.

Further, in a case where the first bypass 10 is eliminated from FIG. 3, if the control unit 20 opens the first shut-off valve 9 during the operation of the hydrogen pump 8 such that the hydrogen pump 8 is opened to the atmosphere, the moisture and the gas including the moisture which has been exhausted from the hydrogen pump 8 are exhausted outside the fuel cell system. In addition, when the first pressure regulating valve 5 is opened, hydrogen is flowed from the hydrogen tank 4 to the hydrogen pump 8 thereby promoting desiccation in the hydrogen pump 8.

In the third preferred embodiment, the control unit 20 has a plurality of the reference temperatures “t1” to “tn”, which are different from each other. In an alternative embodiment to the third preferred embodiment, the control unit 20 has a single reference temperature “to” in place of the reference temperatures “t1” to “tn”. The control unit 20 operates the hydrogen pump 8 when the temperature T of the hydrogen pump 8 detected by the temperature sensor 22 drops to the reference temperature “to”. In this case, the moisture and the gas including the moisture are exhausted from the hydrogen pump 8.

The following temperature detecting means may be employed in place of the temperature sensor 22, which detects temperature of the hydrogen pump 8. For example, a temperature sensor which detects temperature of the inside of the fuel cell system such as the FC stack 1, a valve and a piping, or a temperature sensor which measures outdoor air temperature are used.

As described above, if a rotary pump such as a Roots compressor is adopted as the hydrogen pump 8, water is well drained, and the moisture and the gas including the moisture are efficiently exhausted from the hydrogen pump 8.

The anti-icing system may be integrally provided with the fuel cell system. If the anti-icing system is provided separately from the fuel cell system, the fuel cell system in a state where the operation of the system is stopped does not need to be operated as a whole upon driving the hydrogen pump 8 when the temperature in a predetermined place detected by the temperature sensor drops to the reference temperature. Consequently, energy-saving effect is obtained.

If the anti-icing system is operated only in a state where the operation of the fuel cell system is stopped, higher energy-saving effect is obtained.

The following technical ideas are obtained from the third preferred embodiment and its examples.

1. An anti-icing system for preventing a hydrogen pump in a fuel cell system from freezing includes a temperature detecting means for detecting temperature in a predetermined place and a control unit for operating the hydrogen pump such that moisture in the hydrogen pump and a gas including the moisture are exhausted outside the hydrogen pump if the temperature detected by the temperature detecting means becomes a predetermined reference temperature or below in a state where the operation of the fuel cell system is stopped.

2. The anti-icing system according to the above-mentioned 1, wherein the control unit has a plurality of reference temperatures which are different from each other, and the control unit operates the hydrogen pump for a predetermined time every time the temperature detected by the temperature detecting means reaches each of the reference temperatures.

3. The anti-icing system according to the above-mentioned 1 or 2, wherein the temperature detecting means is a temperature sensor for detecting temperature in the fuel cell system.

4. The anti-icing system according to the above-mentioned 3, wherein the temperature detecting means is a temperature sensor for detecting temperature of the hydrogen pump.

5. The anti-icing system according to the above-mentioned 1 or 2, wherein the temperature detecting means is a temperature sensor for detecting outdoor air temperature.

6. The anti-icing system according to any one of the above-mentioned 1 through 5, wherein the hydrogen pump is a rotary pump.

7. The anti-icing system according to any one of the above-mentioned 1 through 6, wherein the control unit opens a hydrogen flowing passage in the fuel cell system to the atmosphere while the control unit operates the hydrogen pump, thereby exhausting the moisture and the gas including the moisture, which has been exhausted from the hydrogen pump, outside the fuel cell system.

8. The anti-icing system according to the above-mentioned 7, wherein hydrogen is flowed from a hydrogen tank, which supplies hydrogen into the hydrogen flowing passage in the fuel cell system, into the hydrogen pump while the control unit operates the hydrogen pump.

Therefore, the present examples and embodiments are to be considered as illustrative and not restrictive and the invention is not to be limited to the details given herein but may be modified.

1. A fuel cell system comprising:
a fuel cell stack in which electricity is generated through reaction of hydrogen and air;
a hydrogen flowing passage connected to the fuel cell stack for allowing the hydrogen to be supplied to the fuel cell stack;
an air flowing passage connected to the fuel cell stack for allowing the air to be supplied to the fuel cell stack;
a control valve located on the hydrogen flowing passage and the air flowing passage;
and wherein at least one gas flowing passage of the hydrogen flowing passage and the air flowing passage comprises:
a bypass for allowing a gas to flow therethrough so as to detour the fuel cell stack and the control valve;
a means for selecting one of a passage which passes through the fuel cell stack and the bypass;
a means for flowing the gas to the bypass;
a control unit connected to the control valve, the selecting means and the gas flowing means such that the through passage is selected by the selecting means when the system is operated, that the bypass is selected by the selecting means when the operation of the system is stopped, and that the gas is flowed to the bypass by operating the gas flowing means in a case where the control valve is frozen thereby heating the control valve.

2. The fuel cell system according to claim 1, wherein the bypass, the selecting means and the gas flowing means are each located on both of the hydrogen flowing passage and the air flowing passage.

3. The fuel cell system according to claim 1, wherein at least one gas flowing passage of the hydrogen flowing passage and the air flowing passage further comprises a gas circulating passage for allowing an exhaust gas which is exhausted from the fuel cell stack to be circulated toward an upstream of the fuel cell stack, the gas circulating passage, the bypass, the selecting means and the gas flowing means forming a closed circuit when the operation of the system is stopped.

4. The fuel cell system according to claim 1, wherein the selecting means is a shut-off valve which is located on the bypass.

5. The fuel cell system according to claim 1, wherein the selecting means is a three-way valve which is located at a point at which the bypass branches off from the through passage.

6. The fuel cell system according to claim 1, wherein the bypass provides a throttle thereon.

7. The fuel cell system according to claim 1, wherein a diameter of a piping of the bypass is formed so as to be smaller than that of the gas flowing passage.

8. The fuel cell system according to claim 1, wherein the control unit controls operating time of the gas flowing means, or flow rate of gas which is circulated by the gas flowing means in accordance with charging capacity of a battery.

9. The fuel cell system according to claim 1, wherein the gas flowing means is a pump for flowing the gas into the through passage when the system is operated.
